(19) United States
(12) Patent Application Publication
(10) Pub. No.: US 2006/0078314 A1
(43) Pub. Date: Apr. 13, 2006

(54) Webcam communication system using handheld device with camera and method thereof

(76) Inventors: Ching-Ching Hung, Taipei (TW); Chien-Cheng Chiang, Taipei (TW); Chin-Hsing Chang, Taipei (TW)

Correspondence Address: HARNESS, DICKEY & PIERCE, P.L.C., P.O. BOX 8910, RESTON, VA, 20195, US

(21) Appl. No.: 11/203,116

(22) Filed: Aug. 15, 2005

(30) Foreign Application Priority Data
Oct. 12, 2004 (TW) 93130912

(51) Int. Cl. H04N 5/76; H04N 5/225

(52) U.S. Cl. 386/117; 386/125

(57) ABSTRACT

A webcam communication system using a handheld device with a camera and a method used are provided. The system connects the handheld device to a computer executable platform by a transmission interface or a transmission platform at local, such, that the handheld device can be used as a webcam to extract and transmit real-time image and audio to the computer executable platform. In such, a real-time process upon the extracted image and audio is performed by the computer executable platform and a real-time image and audio communication with a remote terminal can be realized via Internet.

### BACKGROUND OF THE INVENTION

1. Field of Invention

The present invention relates to a webcam communication system and a method using the same, which connects a handheld device with a camera to a computer executable platform to establish a real-time communication with a remote terminal.

2. Related Art

Currently, the most popular application of Internet includes real-time communication software (IM) that provides real-time communication between local and remote computer executable platforms. The hardware and software for the computer executable platform and Internet are continuously improving. There is a great demand of real-time communication as well. So the pure text real-time communication cannot satisfy the public any more. Real-time communication in the form of image and audio messages has become the leading trend of communication development.

The most common image and audio communication includes installation of webcams and microphones at the local and remote computer executable platforms to extract the image and sound at both sides. The extracted image and sound are processed by the local and remote computer executable platforms and transmitted to the opposing sides via Internet. However, the installation of webcams and microphones often require pre-configuration and test procedures on specific computers. This causes great inconvenience for users who are not familiar with computer hardware.

To avoid the inconvenience, other designs have to be developed. Currently, the handheld devices with cameras have become more and more popular. A lot of devices such as cellular phones and personal digital assistance (PDA) have incorporated the image recording and sound extraction functions and the quality of the image and sound is all sufficient for most of the users. Further, as the cellular phones are so popular, it is thus a substantial solution to combine these handheld devices with computer hardware and software, to overcome the inconvenience of the conventional image and audio communication device.

### SUMMARY OF THE INVENTION

A webcam communication system and method using a handheld device with a camera are provided.

In one embodiment, the handheld device is connected to a local computer executable platform through a transmission interface. Therefore, the handheld device can be used as a webcam to capture a real-time image and sound, and the captured image and sound are then processed by the local computer executable platform and transmitted to a remote computer executable platform through Internet.

Accordingly, the whole webcam communication system of the present invention includes a local handheld device and a local computer executable platform.

The local handheld device includes a first transmission interface unit, an image unit for capturing image information and an audio unit for capturing sound information to form a video and audio packet.

The local computer executable platform includes a second transmission interface unit, a driving program unit for analyzing and recovering the video and audio packet in the image and sound information, a video and audio communication program unit for processing the image and sound information into video and audio information, and a network connection unit for transmitting the video and audio information to a remote party through Internet

In another embodiment, the handheld device is connected to the local computer executable platform via a transmission platform. Therefore, the handheld device and the local computer executable platform do not require changing both transmission interfaces to perform real-time image and audio communication.

Furthermore, the present invention provides a webcam communication method using a handheld device with a camera. The first embodiment comprises: detecting connection between a local handheld device to a local computer executable platform, activating the local handheld device to capture image information and sound information so as to form a video and audio packet, analyzing the video and audio packet, producing video and audio information, and transmitting the video and audio information to a remote party.

In another embodiment, connection is detected between a local handheld device and a local computer executable platform via a transmission platform, to perform real-time image and audio communication.

### BRIEF DESCRIPTION OF THE DRAWINGS

The present invention will become more fully understood from the detailed description given in the illustration below only, and thus does not limit the present invention, wherein:

FIG. 1A shows the device connection of the system of the invention provided in a first embodiment;

FIG. 1B shows the device connection of the system of the invention provided in a second embodiment;

FIG. 2A shows the block diagram of the first embodiment;

FIG. 2B shows the block diagram of the second embodiment;

FIG. 3A shows the process flow of the first embodiment; and

FIG. 3B shows the process flow of the second embodiment.

### DETAILED DESCRIPTION OF THE INVENTION

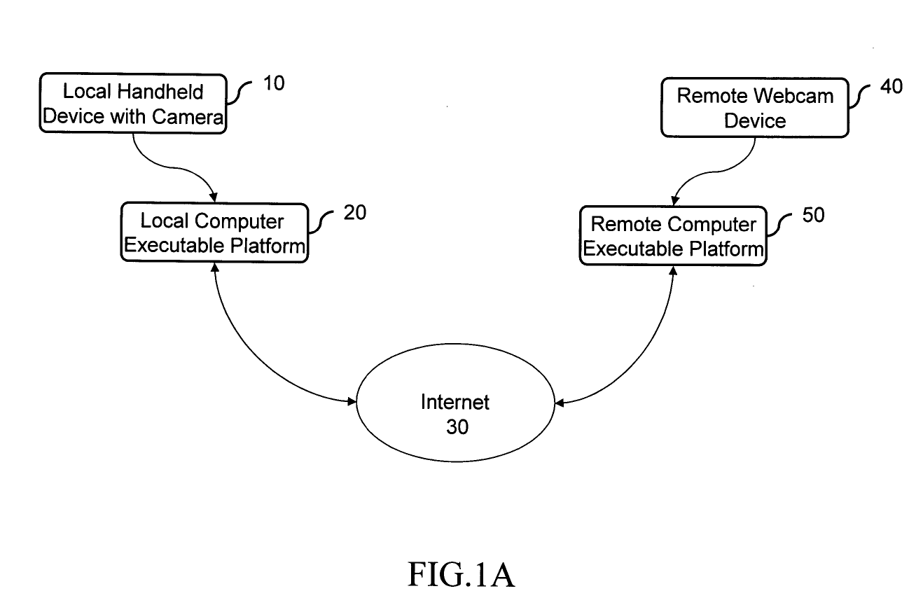

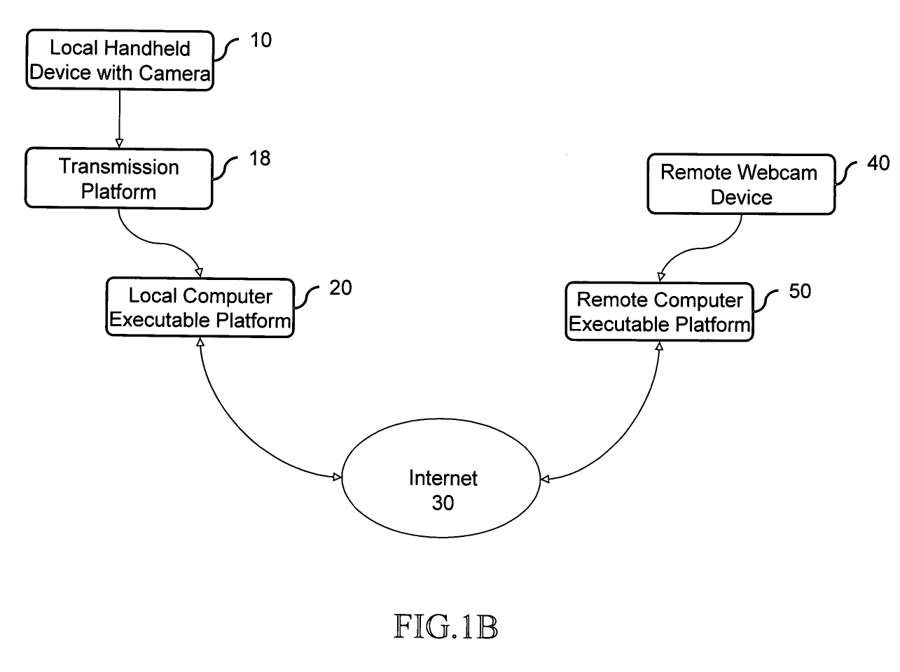

The handheld device communication system and method includes at least two different modes as shown in FIGS. 1A and 1B.

In the first embodiment as shown in FIG. 1A, in a local handheld device with camera 10, connected to a local computer executable platform 20 via a transmission interface such as a universal serial bus (USB), such an image and sound captured or extracted by the local handheld device with camera 10 can be transmitted to the local computer executable platform 20 via the transmission interface. The local computer executable platform 20 then processes the captured image and sound and transmits the processed image and sound to a remote party via Internet 30.

The local handheld device with camera 10 includes a cellular phone or a PDA equipped with a camcorder. The local computer executable platform 20 includes a platform operative to process, connect to network and execute computer programs such as a desktop computer, or a laptop computer. The remote party also requires hardware to perform image and audio communication. For example, the remote party includes a remote computer executable platform compatible with the local computer executable platform and a remote webcam device 40 (not limited to the handheld device).

In the second embodiment as shown in FIG. 1B, an additional transmission platform 18 is inserted between the local handheld device 10 and the local computer executable platform 20. Thereby, different types of transmission can be used to establish communication between the local handheld device 10 and the local computer executable platform 20.

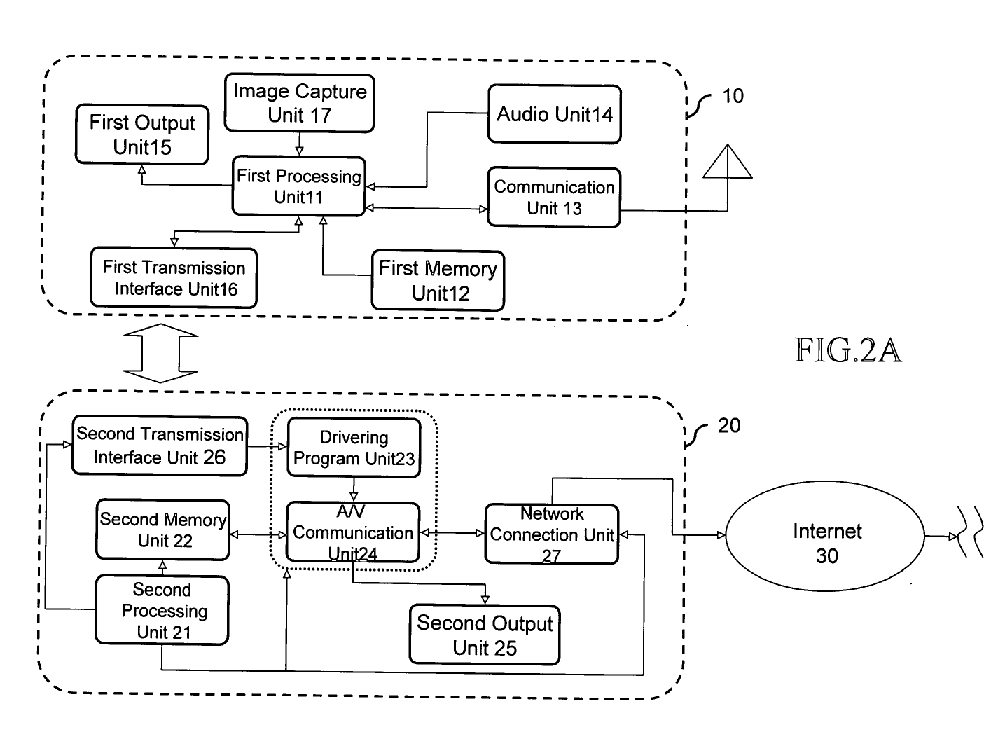

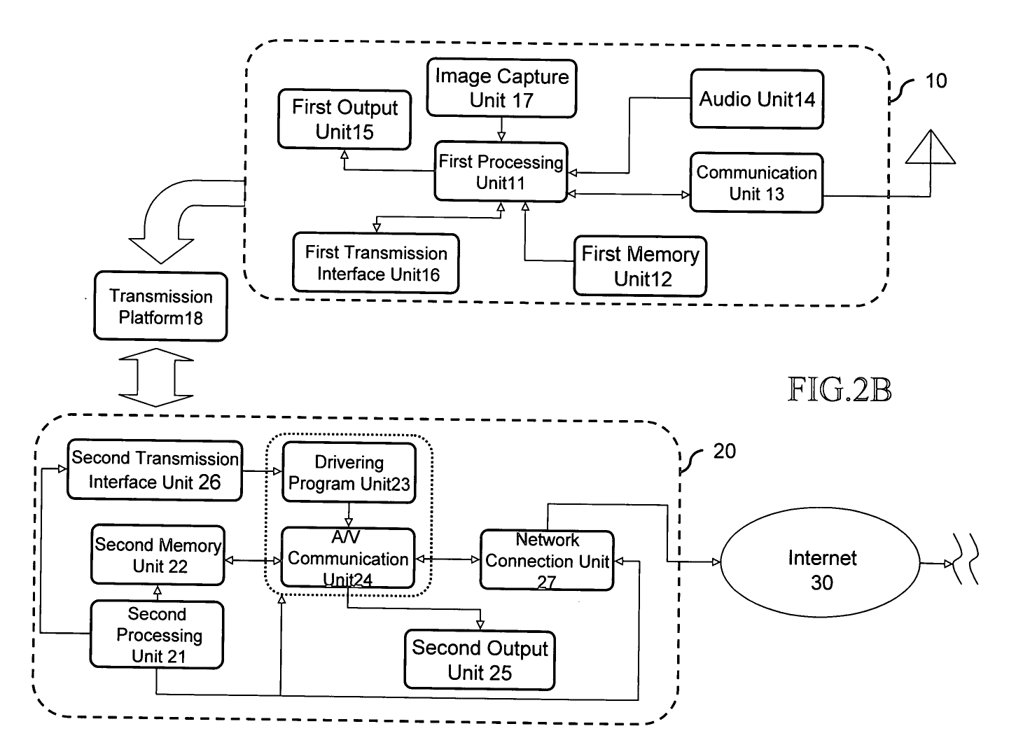

The systems as shown in FIGS. 1A and 1B are illustrated in detail in FIGS. 2A and 2B, respectively.

Referring to FIG. 2A, the local handheld device 10 includes a first processing unit 11, a first memory unit 12, a communication unit 13, an audio unit 14, a first output unit 15, a first transmission interface unit 16 and an image capture unit 17.

The first processing unit 11 is responsible for the control process between all units. The first memory unit 12 is used to store the audio information and image captured by the audio unit 14 and the image capture unit 17. The communication unit 13 (including an antenna) 13 provides wireless communication for the handheld device 10. The first output unit 15 outputs the image and sound captured by the image capture unit 17 and the audio unit 14. The transmission interface 16 is used to connect the local handheld device 10 to the local computer executable platform 20, to allow the local computer executable platform 20 to process the image and sound packets created by the handheld device 10.

The local computer executable platform 20 includes a second processing unit 21, a second memory unit 22, a driving program unit 23, an video and audio communication unit 24, a second output unit 25, a second transmission interface unit 26 and a network connection unit 27.

The second processing unit 21 is responsible for the control process for all units of the local computer executable platform 20. The second memory unit 22 stores the image and sound information transmitted from the local handheld device 10. The driving program unit 23 is used to activate the local handheld device with camera 10 to perform image and sound capture, when the first transmission interface unit 16 of the local handheld device with camera 10 is connected to the second transmission interface unit 26 of the local computer executable platform 20. The driving program unit 23 is also responsible for analyzing the video and audio packets transmitted from the local handheld device 10. The video and audio communication program 24 is used to process the image and sound information, analyzed and recovered by the driving program unit, with a format that can be transmitted through internet 30. The second output unit 25 is used to output the processed video and audio information. Therefore, the second transmission interface unit 26 provides connection and information communication and transmission to the first transmission interface unit 16. The network connection unit 27 allows the user to connect to Internet 30, to perform two-way communication to a remote computer executable platform 50.

The first and second transmission interface units 16 and 26 preferably have the same specifications, preferably USB interfaces. The image capture unit 17 includes a CCD, while the audio unit 14 includes a microphone, for example.

In addition, the driving program unit 23 and the video and audio communication program unit 24 are the computer software programs of the operation systems executed in the local computer executable platform 20. The video and audio communication program unit 24 may further provide a user interface, such, that the user can perform various operations, such as setting up the process pattern of the image and sound information transmitted form the local handheld device 10. The video and audio communication program unit 24 also control whether the processed real-time image and sound information is to be transmitted to the remote computer executable platform 50 or saved in the second memory unit 22. Or whether the image and sound information belongs to stationary image, stream of dynamic video and audio information.

FIG. 2B includes an additional transmission platform 18 between the local handheld device 10 and the local computer executable platform 20. With the transmission platform 18, the first and second transmission interface units 16 and 26 are not required to have the same specification. That is, even when the local handheld device with camera 10 has a different type of transmission interface from that of the local computer executable platform, the communication between the local handheld device with camera 10 and the local computer executable platform 20 can still be established.

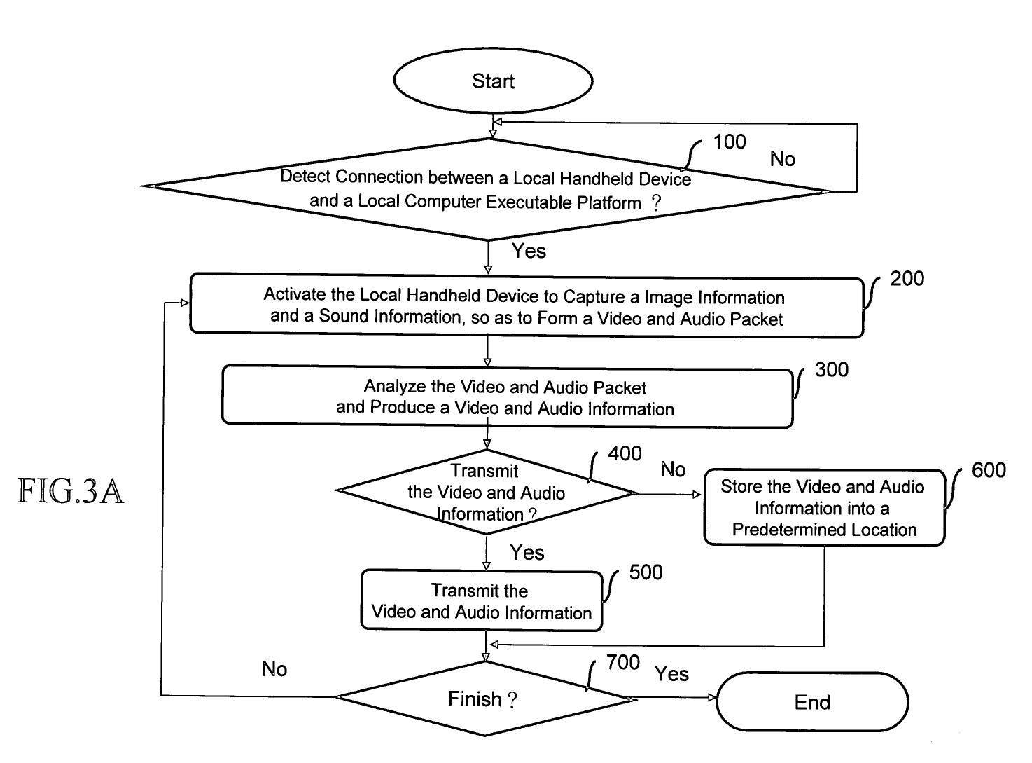

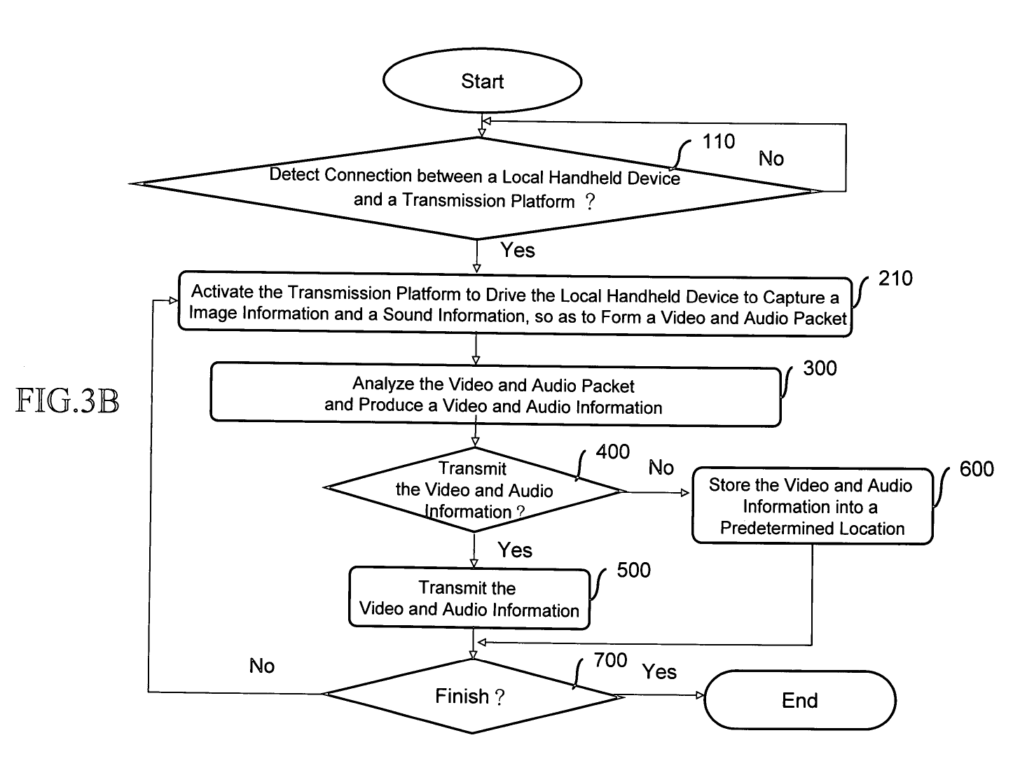

FIG. 3A shows the process flow of the first embodiment.

In step 100, the local computer executable platform 20 is connected to the local handheld device with camera 10. When the connection is established, the driving program unit 23 drives the local handheld device with camera 10 to perform image and sound capture by the image capture unit 17 and the audio unit 14. The captured image and sound are formatted into video and audio packets (processed by the first processing unit 11) and transmitted to the second transmission interface unit 26 from the first transmission interface unit 16 in step 200. Upon receiving the video and audio packets, the driving program unit 23 performs analysis and recovers the video and audio packets into the original image and sound information. By the video and audio process of the video and audio communication program unit 24, the image and sound information are processed and output in step 300. The format of the video and audio information and the process method can be determined by the user interface provided by the video and audio communication program unit 24. For example, stationary images, dynamic stream of images and sounds can be selectively output. Meanwhile, whether the user sets up a real-time transmission of the video and audio information to a remote party is determined in step 400. If so, the video and audio information is transmitted through the Internet 30 by the network connection unit 27 in step 500. If not, the user can select saving the video and audio information into the predetermined location in step 600. Before the user selects terminating the image capture in step 700, the steps 200 to 500 are continued.

FIG. 3B shows the process flow of the second embodiment. The second embodiment differs from the first embodiment by adding the transmission platform 18 between the local handheld device 10 and the local computer executable platform 20. Therefore, in step 110, the transmission platform 18 is used to detect the connection status of the local handheld device with camera 10. In step 200, the local computer executable platform 20 drives the transmission platform 18 to activate the local handheld device 10 for image and sound capture. The image and sound are then processed as video and audio packet. The connection between the first and second transmission interface units 16 and 26 through the second transmission interface unit 26 is thus performed by the local computer executable platform 20 in step 210. The remaining processes are the same as in the first embodiment.

Knowing the invention thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A webcam communication system using a handheld device with a camera, comprising:
a local handheld device, including a first transmission interface unit, an image unit for capturing image information and an audio unit for capturing sound information to form a video and audio packet; and
a local computer executable platform including a second transmission interface unit, a driving program unit for analyzing and recover the video and audio packet into the image and sound information, a video and audio communication program unit for processing the image and sound information into a video and audio information, and a network connection unit for transmit the video and audio information to a remote party through internet; wherein
when the first transmission interface unit is connected to the second transmission unit, the driving program unit activates the local handheld device to transmit the video and/or audio packet to the local computer executable platform.

2. The system of claim 1, wherein the local handheld device is selected from the group of a cellular phone, a personal digital assistant, and a pocket personal computer, which is equipped with a camcorder.

3. The system of claim 1, further comprising a transmission platform for connecting the first and second transmission interface units.

4. The system of claim 1, wherein the first and second transmission interface units include USB interfaces.

5. The system of claim 1, wherein the image capture unit includes a CCD.

6. The system of claim 1, wherein the audio unit includes a microphone.

7. The system of claim 1, wherein the local handheld device further comprises a first processing unit for control process of all units of the local handheld device, a first output unit to output the image and sound information, a first memory unit to store the image and sound information and a communication unit to provide wireless communication.

8. The system of claim 1, wherein the local computer executable platform further comprises a second processing unit to control process of the local computer executable platform, a second output unit for outputting the image and sound information, and a second memory unit for storing the image and sound information.

9. The system of claim 1, wherein the video and audio communication program unit is operative to stored the video and audio information to a predetermined location of the second memory unit.

10. The system of claim 1, further comprising a user interface allowing a user to perform real-time process of the video and audio information.

11. The system of clam 1, wherein the video and audio information includes a stationary image, a dynamic stream of images and sounds and a group of sounds.

12. A webcam communication method using a handheld device with a camera, comprising the steps of:
detecting connection between a local handheld device and a local computer executable platform;
activating the local handheld device to capture a image information and a sound information, so as to form a video and audio packet;
analyzing the video and audio packet and producing a video and audio information; and
transmit the video and audio information to a remote party; wherein
the local handheld device includes a first transmission interface unit connected to a second transmission interface unit of the local computer executable platform for activating the local handheld device.

13. The method of claim 12, wherein the local handheld device is selected from the group of a cellular phone, a personal digital assistant, and a pocket personal computer, which is equipped with a camcorder.

14. The method of claim 12, further comprising the first and second transmission interface unit through a transmission platform.

15. The method of claim 12, wherein the first and second transmission interface units include USP interfaces.

16. The method of claim 12, further comprising storing the video and audio information into a predetermined location of the local computer executable platform.

17. The method of claim 12, further comprising a step of providing a user interface allowing a user to select real-time process of the video and audio information.

18. The method of claim 12, wherein the video and audio information is formatted into a stationary image, a dynamic stream of images and sounds, and a group of sounds.
